(19) United States
(12) Patent Application Publication
(10) Pub. No.: US 2001/0053176 A1
(43) Pub. Date: Dec. 20, 2001

(54) Method and apparatus for characterizing and adjusting a crystal oscillator for use in a spread spectrum, frequency hopping transceiver

(76) Inventors: Terry L. Fry, Davidsonville, MD (US); Robert P. Sagusti, Greenbelt, MD (US)

Correspondence Address: J. Andrew McKinney, Jr., Adelberg, Rudow, Dorf,, Hendler & Sameth, LLC, 600 Mercantile Bank & Trust Bldg., 2 Hopkins Plaza, Baltimore, MD, 21201-2927, US

(21) Appl. No.: 09/752,388

(22) Filed: Dec. 29, 2000

Related U.S. Application Data
(60) Provisional application No. 60/193,932, filed on Mar. 31, 2000.

(51) Int. Cl. H04K 1/00; H04B 15/00

(52) U.S. Cl. 375/133

(57) ABSTRACT

An economical, compact frequency hopping spread spectrum wireless data telemetry transceiver is adapted to establish and maintain communication links at 2.4 GHZ. The wireless transceiver includes RF and computer control components in a compact package approximately the size of a deck of cards and is adapted to be built into original equipment manufacturer (OEM) products to support a wide range of wireless data telemetry applications. The transceiver includes an inexpensive VCO which is controlled by novel method including steps to characterize and adjust the frequency output of the crystal. As ambient temperature around a quartz crystal varies, the resonant frequency of the crystal varies, in different ways, depending on the method used to cut the crystal from a quartz blank. Employing a quartz crystal in an oscillator circuit to generate a reference frequency subjects the oscillator to the same frequency variations over temperature as the quartz crystal. In accordance with the present invention, a temperature sensor constantly outputs a signal proportional to the temperature of the crystal in the oscillator. A micro-controller initiates a conversion via the analog to digital converter (ADC) and the micro-controller then uses the ADC output signal to look up an adjustment number in a pre-programmed lookup table; the adjustment number is input to the digital to analog converter, which then performs a conversion to output a DC voltage to the VCO, adjusting the frequency of the oscillator to the desired reference frequency, thus effectively providing an open loop VCO control system.

### Related Application Information

The instant non-provisional patent application is a continuation-in-part and claims benefit of co-pending provisional patent application No. 60/193,932, entitled Frequency Discriminator Quadrature Filter and filed Mar. 31, 2000, the entire disclosure of which is incorporated herein by reference.

### BACKGROUND OF THE INVENTION

1. Field of the Invention

The present invention relates to a method and apparatus for characterizing and adjusting a quartz crystal voltage controlled oscillator (VCO) adapted for use in a spread spectrum frequency hopping transceiver.

2. Discussion of the Prior Art

Infrared and radio frequency (RF) data transmission methods are the principal wireless communication technologies described in the prior art. Infrared beam communications systems cannot operate over distances of more than a few feet and so are limited to applications such as bar code scanning and television (or other home appliance) remote control.

As a result, most of the prior art wireless data transmission products utilize standard RF technology, i.e., radios, the same technology used in vehicle dispatch and police communication systems. Standard RF products are relatively simple and inexpensive to build, but for operation FCC licenses may be required. RF transmissions are susceptible to interference from a growing number of sources and to interception by readily available eavesdropping equipment. The unreliable quality of standard RF transmissions makes the technology unsuitable for applications where all of the information transmitted must be accurate, complete, and secure.

In order to overcome the shortcomings of standard RF transmission methods, direct sequence spread spectrum (DSSS) was developed. DSSS radios divide or slice transmissions into small bits, thereby spreading energy from the bits simultaneously across a wide spectrum of radio frequencies. DSSS is a relatively unreliable transmission medium, however, because spreading the message across a wide spectrum greatly reduces the strength of the radio signal carrying the message on any one frequency. Since a DSSS receiver must simultaneously monitor the entire allotted spectrum, severe interference from a high energy RF source within the monitored spectrum can pose an insurmountable problem. DSSS performance also degrades quickly in shared-service environments having multiple radio systems operating simultaneously.

Frequency hopping spread spectrum (FHSS) technology was developed by the U.S. military to prevent interference with or interception of radio transmissions on the battle field and is employed by the military in situations where reliability and speed are critical. Standard RF and DSSS cannot match the reliability and security provided by frequency hopping. Instead of spreading (and therefore diluting) the signal carrying each bit across an allotted spectrum, as in DSSS, frequency hopping radios concentrate full power into a very narrow spectral width and randomly hop from one frequency to another in a sequence within a defined band, up to several hundred times per second. Each FHSS transmitter and receiver coordinate the hopping sequence by means of an algorithm exchanged and updated by both transmitter and receiver on every hop. Upon encountering interference on a particular frequency, the transmitter and receiver retain the affected data, randomly hop to another point in the spectrum and then continue the transmission. There should always be frequencies somewhere in the spectrum that are free of interference, since neither benign producers of interference or hostile jammers will likely interfere with all frequencies simultaneously and at high power radiation levels, and so the frequency hopping transmitter and receiver will find frequencies with no interference and complete the transmission. This ability to avoid interference enables FHSS radios to perform more reliably over longer ranges than standard RF or DSSS radios. In the prior art, frequency hopping FHSS communication systems have been used almost exclusively in the extremely expensive robust military or government communication systems.

Generally speaking, data telemetry is the transmission of short packets of information from equipment or sensors to a recorder or central control unit. The data packets are transferred as electric signals via wire, infrared or RF technologies and data is received at a central control unit such as a computer with software for automatically polling and controlling the remote devices. The control unit analyzes, aggregates, archives and distributes the collected data packets to other locations, as desired, via a local area network (LAN) and/or a wide area network (WAN). Wireless data telemetry provides several advantages over data telemetry on wired networks. First, wireless systems are easier and less expensive to install; second, maintenance costs are lower; third, operations can be reconfigured or relocated very quickly without consideration for rerunning wires, and fourth, wireless telemetry offers improved mobility during use.

Not just any wireless telemetry system will do for many applications, however. The realities of the marketplace dictate that data telemetry cannot be the most expensive part of a system having commercial application. For example, if a retail point-of-sale cash register is to be configured with a wireless data telemetry radio; the radio cannot be more expensive than the cash register. In many commercial applications, buyers have fixed expectations for what things cost and new features, however useful, cannot substantially exceed those expectations. Thus, it would be best if the wireless data telemetry radio were free. In the interest of providing the most economical wireless data telemetry radio, an MSK transceiver is suggested, but how is the goal of delivering a system with truly useful receiver sensitivity to be accomplished? Spec. designed or off-the-shelf receiver sections are expensive, can have a high parts count, and often require excessive energy, when configured for use in a wireless data telemetry radio. It is desirable to have a wireless data telemetry radio be small, light, resistant to interference from adjacent RF noise sources, and use as little energy as possible.

The Federal Communications Commission (FCC) has designated three license-free bandwidth segments of the radio frequency spectrum and made them available for industrial, scientific and medical (ISM) use in the United States. These three segments are 900 MHZ, 2.4 GHz and 5.8 GHz. Anyone may operate a wireless network in a license-free band without site licenses or carrier fees and is subject only to a radiated power restriction (i.e., a maximum of one watt radiated power). The radio signals transmitted must be spread spectrum. Foreign national spectrum regulation organizations and international telecommunications bodies have also agreed to recognize a common license-free ISM frequency at 2.4 GHz, and so a defacto international standard for license-free ISM communications has emerged. The ISM band at 2.4 GHz provides more than twice the bandwidth capacity and is subject to far less congestion and interference than the ISM band at 900 MHZ. Several industrial nations do not permit a license-free ISM band at 900 MHZ and relatively few nations have a license-free ISM band at 5.8 GHZ, but the United States, Europe, Latin America and many Asian countries have adopted an ISM band at 2.4 GHZ.

In accordance with prior art design practices, a transceiver may include one or more expensive Temperature Compensated Crystal Oscillator (TCXO), to provide usable sensitivity in a frequency hopping, spread spectrum transceiver. While buying TCXO's may absolve the designer of meeting the rigorous technical specifications for the transceiver, a substantial cost is added to each transceiver sold. In addition, crystal properties can change over time so that a TCXO may, over time, become less precisely compensated over a range of temperatures. Usually, a TCXO manufacturer will characterize a crystal over a range of temperatures and the characterization data is used to compensate the TCXO's VCO control signal, hopefully providing a precisely adjusted frequency output. As the crystal ages and changes, that compensating adjustment becomes progressively less correct for the crystal, and TCXO manufacturers do not provide free recalibration of the characterization data.

What is needed, then, is an inexpensive, easy to use and robust data telemetry and communication system including an inexpensive transceiver, preferably operating in the common license-free ISM frequency band and providing carefully calibrated and reliable communications for a variety of users in commercial and industrial environments.

### OBJECTS AND SUMMARY OF THE INVENTION

Accordingly, it is a primary object of the present invention to overcome the above mentioned difficulties by providing an economical, compact frequency hopping spread spectrum wireless data telemetry transceiver is adapted to establish and maintain communication links in the license-free ISM frequency band at 2.4 GHZ.

Another object is to provide a transceiver that is relatively inexpensive, and yet is up to the task of providing usable sensitivity in a frequency hopping, spread spectrum communication system.

Yet another object of the present invention is to implement a modulator and demodulator of usable frequency accuracy and stability with the smallest and most economical parts count.

Another object is to provide a transceiver VCO that is relatively inexpensive, and yet is up to the task of providing usable precision and long term frequency stability over a range of temperatures as required for use in a frequency hopping, spread spectrum communication system.

The aforesaid objects are achieved individually and in combination, and it is not intended that the present invention be construed as requiring two or more of the objects to be combined unless expressly required by the claims attached hereto.

In accordance with the present invention, an economical, compact frequency hopping spread spectrum wireless data telemetry transceiver is adapted to establish and maintain communication links at 2.4 GHZ in the license-free ISM frequency band and preferably provides the optimum balance between data rate and range, in one embodiment providing 9.6 kilobits per second (9.6 Kbps) data transmission over an outdoor line of sight range of approximately 35 thousand meters. The transceiver of the present invention includes an inexpensive Crystal Oscillator, calibrated in-situ on the RF board, using a novel method and test fixture, in place of the traditional and expensive TCXO.

The transceiver includes an inexpensive VCO which is controlled by novel method including steps to characterize and adjust the frequency output of the crystal. As ambient temperature around a quartz crystal varies, the resonant frequency of the crystal varies, in different ways, depending on the method used to cut the crystal from a quartz blank. Employing a quartz crystal in an oscillator circuit to generate a reference frequency subjects the oscillator to the same frequency variations over temperature as the quartz crystal. In accordance with the present invention, a temperature sensor constantly outputs a signal proportional to the temperature of the crystal in the oscillator. A micro-controller initiates a conversion via the analog to digital converter (ADC) and the micro-controller then uses the ADC output signal to look up an adjustment number in a pre-programmed lookup table; the adjustment number is input to the digital to analog converter, which then performs a conversion to output a DC voltage to the VCO, adjusting the frequency of the oscillator to the desired reference frequency, thus effectively providing an open loop VCO control system.

If it is discovered that the crystal properties have changed over time, the crystal characterization procedure can be repeated, whereupon the pre-programmed lookup table is provided with updated information permitting more accurate adjustment of the oscillator frequency.

The frequency hopping spread spectrum communication system of the present invention includes components ideally suited to specific wireless data telemetry applications. A long range transceiver is configured as a printed circuit card having an edge connector. The wireless transceiver includes RF and computer control components in a compact package approximately the size of a deck of cards and is adapted to be built into original equipment manufacturer (OEM) products to support a wide range of wireless data telemetry applications. Each long range transceiver includes a shielded RF board or module with a frequency hopping transmitter and receiver (including the demodulator), an antenna, and a digital control board or module. The digital control module performs RF module and application interface management and an application interface is included to communicate with specific OEM products utilizing serial (transistor/transistor logic, TTL) or other standard interfaces. The transceiver operates in the license-free portion of the FCC designated ISM frequency band at 2.4 GHZ; the transceiver transmits and receives data at 9.6 Kbps at ranges of up to 1500 feet when used indoors with the integrally housed antenna, or up to 12 miles line of sight when used outdoors with an optional directional antenna. The transceiver transmits or receives on any of 550 independent, non-interfering frequencies. When using the transceiver, a data telemetry network can readily be configured for either point-to-point (e.g. wire replacement) or host-to-multipoint networks linked to a user's existing computer or to telephone networks via a system gateway. Optionally, up to 5 collocated independent networks may operate simultaneously, and data security is provided by rapid and random frequency changes (i.e., frequency hopping); the transceiver can optionally be used with data encryption software for providing secure, coded transmissions.

Alternatively, a long range connector transceiver can be attached to a computer or other device using a standard serial (RS232) port. The long range connector duplicates the functions of the long range transceiver but is housed in an enclosure having a cord terminated with an RS232 compatible connector. The long range connector can therefore be used with a wide variety of existing products such as cash registers, ATM machines, laptop computers or any other computer controlled device having an RS232 port and capable of utilizing the frequency hopping spread spectrum communication system software described in the attached appendices.

A plurality of optional antennas can be used with either the transceiver or the long range connector. The standard antenna included with either the long range connector or the long range transceiver is an omni-directional antenna having vertical polarization and a spherical radiation pattern, is built into the transceiver or connector housings and does not require an added cable.

The transceiver functions as a half duplex, bi-directional communication device; transmit and receive functions are time interleaved in a non-overlapping fashion, consistent with the requirements of a frequency hopping radio. The transmit interval is restricted to less than 0.4 seconds. In the course of a normal information exchange, a given transmission is generated on a frequency selected from a set of all available hop frequencies. The transmission is limited in duration to the availability of incoming data, and following the transmission, the radio switches to a receive mode and demodulates any incoming data. Once reception is complete, the transmit interval/receive interval cycle is restarted on a new frequency selected from the hop frequency set. Transmit receive cycling continues until all 75 unique frequencies in the set have been used, whereupon the frequency selection process reenters the top of the table and begins reusing the same 75 frequencies.

As alluded to above, transmitted data is directly modulated onto a synthesized carrier by use of minimum shift keying (MSK) modulation. The receiver is a dual conversion super heterodyne, down converting the received signal first to a 315 MHZ intermediate frequency (IF) signal and then down converting a second time to a 10.7 MHZ IF signal. In accordance with the present invention, demodulation is accomplished using a novel frequency discriminator quadrature filter and limiter/discriminator circuit and the demodulated data is recovered from the demodulator output by processing through a comparator. First and second local oscillators (LOs) are controlled in frequency by use of a single loop indirect frequency synthesis. Samples of both first and second voltage controlled oscillators (VCOs) are divided down using phase-locked loop integrated circuit elements, where each sample is compared to an onboard 8 MHZ crystal reference oscillator. During the transmit interval, a single transmitter VCO is controlled by the same device and in the same manner.

To minimize total power consumption within the transceiver, portions of circuitry not in use during either the transmit or receive intervals are disabled under control of the system controller.

The RF Board consists of transmitter, receiver, frequency synthesizer and T/R switch sections. Each of these sections is controlled by an external microprocessor to either transmit serial data or receive serial data. The basic transmitted signal is generated by a voltage-controlled-oscillator (VCO) that operates in the 2.4 to 2.4835 GHZ frequency band. The signal is then amplified by three stages of amplification. All three amplification stages and the VCO are switched ON for transmit and switched OFF for receive. A power amplifier stage provides 26 dBm of output power to drive the antenna. This stage also uses a GaAs RF Power FET and a similar power control circuit. The transmitted signal passes through the T/R switch and a 2.44 GHZ 4-pole bandpass filter to the antenna. Both the T/R switch and the bandpass filter are implemented using strip line on a separate daughter board.

The receiver uses dual conversion with a first IF of 315 MHZ and a second IF of 10.7 MHZ. The received signal from the antenna passes through the same 2.44 GHZ filter the transmitted signal passed through and then passes through the T/R switch to a Low Noise Amplifier (LNA) included as part of a receiver pre-amp stage.

The analog serial data stream is digitized by thresholding the signal using a comparator and a threshold generated from a peak follower. The peak follower follows both the positive and negative peaks of the analog serial data stream and then generates a threshold signal that is half way between the two peaks. The output of the comparator is the digital received signal output to the digital board.

The RF Board includes an I/O Interface which consists of two mechanical connections. Most of the connections are made via a 20 pin dual in-line header. The other connection is for the antenna and is a microstrip pad and ground connection to which the coaxial antenna cable is soldered. TTL-compatible input signals on the Rx/Tx-pin are used to control the T/R switch. A logic high on this pin puts the T/R switch in the receive position and a logic low puts it in the transmit position. Before the radio switches from receive mode (Rx) to transmit mode (Tx), the T/R switch should be put in the Tx position. When switching from Tx to Rx the T/R switch should remain in the Tx position until after the radio is switched from Tx to Rx.

The RF Board includes an RF I/0 connection. When data is presented to the serial port of the digital board, firmware on the digital board will cause the radio to hop on 75 frequencies in the 2400-2483.5 MHz band. The dwell time for each hop is 31.6 ms. During a single hop, the carrier is frequency modulated with the transmit serial data stream from the digital board. Immediately after the transmit time period, the transceiver switches to the receive mode.

As noted above, an inexpensive Crystal Oscillator is calibrated in-situ on the RF board, using a novel method and test fixture in place of the traditional and expensive TCXO. The method is implemented in a test/calibration controller software algorithm including a selected number of curves representing Crystal Oscillator frequency variation as a function of temperature, for a selected range of temperatures. The off-the-shelf, non-calibrated Crystal Oscillator is characterized in-situ on a transceiver RF board by actuating the crystal at a first selected temperature, measuring the crystal's frequency of oscillation, changing the temperature of the crystal (and the rest of the RF board) to a second selected temperature, measuring the crystal's frequency of oscillation at the second selected temperature, and then using the two points to select a best-fit curve describing the temperature variation of the crystal under test. Each transceiver then has its crystal oscillator characterized in-situ, and the characterization data is stored, preferably in a read-only-memory (ROM), for use with an onboard temperature sensor, so each transceiver self corrects for temperature variations in real time, when in use. If a transceiver is serviced and the Crystal Oscillator are replaced, the method of the present invention can be repeated, to calibrate transceiver performance to the new crystal.

The applicants have discovered that there are an optimally useful number of curves representing Crystal Oscillator frequency variation as a function of temperature for a selected range of temperatures. The data from the curves are stored in a test controller's memory and are included in the test/calibration software. Preferably, by measuring only two temperature/frequency points in-situ, on the RF board, enough data is gathered to select the best fitting curve from those stored in the test controller's memory. The curves represent frequency as a function of temperature for a temperature range that far exceeds the cold and hot temperature limits of the transceiver. The best fitting curve data is selected and uploaded to a ROM on the transceiver's digital board for use in adjusting or calibrating the VCO's output.

The above and still further objects, features and advantages of the present invention will become apparent upon consideration of the following detailed description of a specific embodiment thereof, particularly when taken in conjunction with the accompanying drawings, wherein like reference numerals in the various figures are utilized to designate like components.

### BRIEF DESCRIPTION OF THE DRAWINGS

FIG. 1 is a block diagram of a frequency hopping spread spectrum transceiver, in accordance with the present invention.

FIG. 2 is a perspective view of the transceiver of FIG. 1, in accordance with the present invention.

FIG. 3 is a perspective view of a long range connector, in accordance with the present invention.

FIG. 4a is a perspective view of an omni-directional antenna adapted for use with the transceiver of FIG. 1, in accordance with the present invention.

FIG. 4b is a perspective view of a larger omni-directional antenna adapted for use with the transceiver of FIG. 1, in accordance with the present invention.

FIG. 4c is a perspective view of a directional antenna adapted for use with the transceiver of FIG. 1, in accordance with the present invention.

FIG. 4d is a perspective view of a high gain directional antenna adapted for use with the transceiver of FIG. 1, in accordance with the present invention.

FIG. 5 is a schematic circuit diagram of the transceiver crystal oscillator, in accordance with the present invention.

FIG. 6 is a diagram of fifteen exemplary measured frequency/temperature curves, each passing through a reference temperature, RT, in accordance with the present invention.

FIG. 7 is a block diagram of an open loop frequency control circuit, in accordance with the present invention.

FIG. 8 is a diagram of the temperature data gathering set up, in accordance with the present invention.

### DETAILED DESCRIPTION OF THE PREFERRED EMBODIMENTS

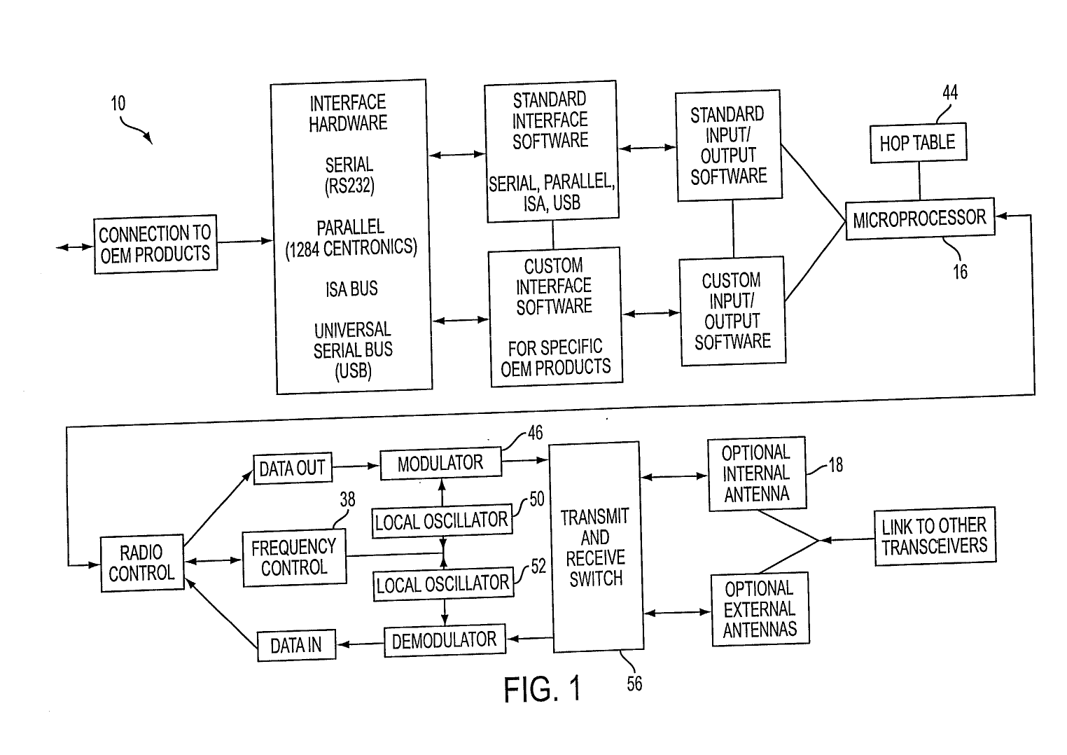

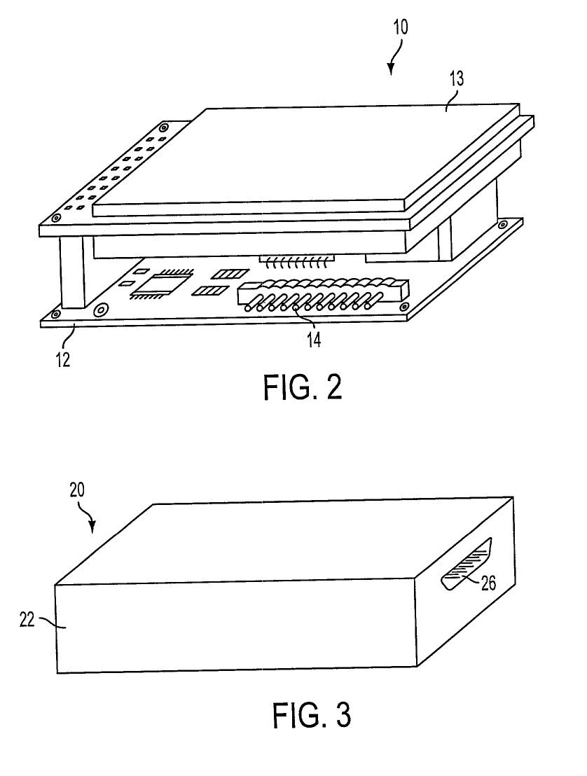

In accordance with the present invention, a frequency hopping, spread spectrum communication transceiver 10 is adapted to dynamically establish and maintain communication links between two or more transceivers and includes components ideally suited to wireless data telemetry applications. As shown in FIGS. 1 and 2, transceiver 10 is configured as a stacked pair of printed circuit cards including a digital board 12 connected to a shielded RF board 13, the digital board carries a multi-pin connector 14. Transceiver 10 includes RF and computer control components in a compact package approximately the size of a deck of cards and is adapted to be built into original equipment manufacturer (OEM) products to support a wide range of wireless data telemetry applications. Shielded RF board 12 includes a frequency hopping transmitter and receiver, as well as an antenna. The digital control module micro processing unit (MPU) 16 performs RF module and application interface management and an application interface is included to communicate with specific OEM products utilizing serial (transistor/transistor logic, TTL) or other standard interfaces. Transceiver 10 operates in the license-free portion of the FCC designated ISM frequency band at 2.4 GHZ, transmitting and receiving data at 9.6 Kbps at ranges of up to 1500 feet when used indoors with the integrally housed antenna 18, or up to 12 miles line of sight when used outdoors with an optional directional antenna. Transceiver 10 transmits or receives on any of 550 independent, non-interfering frequencies. When using transceiver 10, a data telemetry network can readily be configured for either point-to-point (e.g. wire replacement) or host-to-multipoint networks linked to a user's existing computer or to telephone networks via a system gateway. Optionally, up to 5 collocated independent networks may operate simultaneously, and data security is provided by rapid and random frequency changes (i.e., frequency hopping); transceiver 10 can optionally be used with data encryption software for providing secure, coded transmissions.

Alternatively, a long range connector transceiver 20 as shown in FIG. 3 can be attached to a computer or other device using a standard serial (RS232) port. The long range connector 20 duplicates the functions of the long range transceiver of FIGS. 1 and 2 but is housed in an enclosure 22 having an RS232 compatible connector 26. The long range connector 20 can therefore be used with a wide variety of existing products such as cash registers, ATM machines, laptop computers or any other computer controlled device having an RS232 port and capable of utilizing a frequency hopping spread spectrum communication system software package used to configure a user's or vendor's particular system.

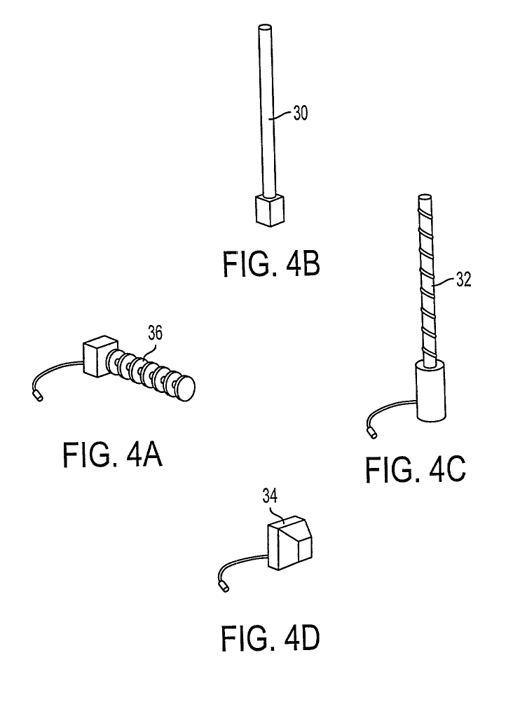

As best seen in FIGS. 4a-4d, a plurality of optional antennas can be used with either transceiver 10 of FIG. 2 or the long range connector 20 of FIG. 3. In particular, the four inch high mast antenna 30 of FIG. 4b provides moderately enhanced performance and an omnidirectional pattern; the 28 inch high phased array antenna 32 of FIG. 4c provides substantially improved performance in all horizontal directions. The 6 inch flat square panel antenna 34 of FIG. 4d provides substantially improved performance in a single direction, and the 30 inch long tube antenna 36 of FIG. 4a provides dramatically improved performance in a single direction by providing a highly directional beam width. The standard antenna 18 included with either the long range connector 20 of FIG. 3 or the long range transceiver 10 of FIG. 2 is an omni-directional antenna having vertical polarization and a spherical radiation pattern. Standard antenna 18 is built into transceiver 10 or connector housing 22 and does not require an added cable. The four optional antennas of FIGS. 4a-4d are adapted to be connected using selected cable links or connectors, as required for a specific application.

Transceiver 10 functions as a half duplex, bi-directional communication device over the air. The transmit and receive functions are time interleaved in a non-overlapping fashion, consistent with the requirements of a frequency hopping radio. The transmit interval is restricted to less than 0.4 seconds on any particular frequency within a thirty second interval. In the course of a normal information exchange, a given transmission is generated on a frequency selected from a set of all available hop frequencies stored in hop table 44. The transmission is limited in duration to the availability of incoming data (or the data payload size for that frame) and following the transmission, the radio switches to a receive mode and processes any incoming data. Once reception is complete, the transmit interval/receive interval cycle is restarted on a new frequency selected from the hop frequency set. Transmit receive cycling continues until all 75 unique frequencies in the set have been used, whereupon the frequency selection process reenters the top of the hop table and begins reusing the same 75 frequencies.

Transmitted data is directly modulated using modulator 46 onto a synthesized carrier by use of minimum shift keying (MSK) modulation. The receiver is a dual conversion super heterodyne, down converting the received signal first to a 315 MHZ intermediate frequency (IF) signal and then down converting a second time to a 10.7 MHZ IF signal. Demodulation is accomplished using a limiter/discriminator circuit and the demodulated data is recovered from the demodulator output by processing through a comparator. First and second local oscillators (LOs) 50,52 are controlled in frequency by frequency control circuit 38 which performs a single loop indirect frequency synthesis. Samples of both first and second voltage controlled local oscillators (VCOs) 50,52 are divided down using phase-locked loop integrated circuit elements, where each sample is compared to an onboard 8 MHZ crystal reference oscillator. During the transmit interval, a single transmitter VCO is controlled by the same device and in the same manner.

To minimize total power consumption within the transceiver, portions of circuitry not in use during either the transmit or receive intervals are disabled under control of the system controller 16.

Frequency management is accomplished by a method incorporated in the transceiver control software. The transceiver initially powers up in an “idle slave” mode and operates in receive mode only, stepping through all 75 hop frequencies while “listening” for an incoming header packet matching the idle slave's local address.

When data is presented to a transceiver via its local communications port (e.g., RS-232), the transceiver immediately shifts from idle slave mode to a “master search” mode wherein the master transmits and then listens for (receives) an acknowledgment signal from a targeted remote slave device (i.e., a transceiver in idle slave mode). The transmit and receive periods each represent one-half of a complete hop interval. The master continues to search for the slave device until a valid acknowledgment is received or until a predetermined time-out period expires. The initiation of master search mode starts at whichever hop frequency the transceiver was previously using while in idle slave mode and continues to step through the hop table selecting frequencies in turn. Since the incoming data is a synchronous in nature, the master transceiver essentially begins this process at a random point within the hop table.

An idle slave device, after receiving a valid header data packet, transmits an acknowledgment packet during the master's listening phase of the hop interval, thereby creating a synchronized and linked session for data transfer. Once linked, the master and slave transceivers increment through all 75 entries in the hop table for as long as incoming data is present for either unit, after a programmable time-out period. The master transmits during the first half of each hop interval and the slave transmits during the second half of the interval with the slave device adjusting its response time in accordance with the received data packet, thereby maintaining synchronization between both master and slave devices. When neither master nor slave has any additional data to transmit, both units return to the idle slave mode after a preprogrammed time-out period.

The receiver portion of the transceiver is implemented very economically; the recovered analog serial data stream is digitized by thresholding the signal using a comparator and a threshold generated from a peak follower. The peak follower follows both the positive and negative peaks of the analog serial data stream and then generates a threshold signal that is half way between the two peaks. The output of the comparator is the digital received signal directed to digital board 12. A universal asynchronous receiver-transmitter (UART) is incorporated in each transceiver to process both transmit and received data.

Transceivers communicate using an On-Air Protocol that is stored in firmware and includes specific characteristics for the two types of on-air “frames”, i.e., the linking frame and the data frame. The linking frame is transmitted when transceivers are not currently communicating to synchronize them to the same frequency. Once the transceivers are synchronized, data frames are transmitted until the (then) current session ends, even if there is no data to be sent. “Synchronization”, as used here, does not mean that precisely synchronized clocks (i.e., between transceivers) are required, however.

Turning now to a more detailed description of transceiver RF components, RF Board 13 consists of a transmitter, receiver, frequency synthesizer and a transmit/receive (T/R) switch. Each of these sections is controlled by microprocessor 16 to either transmit serial data or receive serial data.

The basic transmitted signal is generated by a voltage-controlled-oscillator (VCO) that operates in the 2.4 to 2.4835 GHZ frequency band. The signal is then amplified by three stages of amplification. All three amplification stages and the VCO are switched ON for transmit and switched OFF for receive.

The first stage of amplification is provided by a bipolar transistor capable of generating at least 10 dBm output power to boost the signal generated by the VCO and drive the exciter stage and to provide some isolation between the power stages and the VCO. The base bias on both the VCO and bipolar amplifier is controlled to provide the transmit ON/OFF function.

The exciter stage boosts the power to at least 22 dBm to drive the power amplifier stage. The is accomplished using a GaAs RF Power FET. A power control circuit is used to generate the gate bias voltage. The circuit is a closed loop control circuit that controls the level of drain current. Different drain current settings are used to control the output power of the amplifier. This includes the OFF state for receive as well as three other power levels. The power level settings are programmed via two control lines accessible at the RF Board connector. The circuit also controls the turn-on and turn-off times so that spectral splatter can be reduced.

The power amplifier stage provides 26 dBm of output power to drive the antenna. This stage also uses a GaAs RF Power FET and a similar power control circuit. The same two control lines that control the exciter power level also control the power amplifier power level. The transmitted signal passes through T/R switch 56 and a 2.44 GHZ 4-pole bandpass filter to the antenna. Both T/R switch 56 and the bandpass filter are implemented using strip line on a separate daughter board.

As noted above, the receiver uses dual conversion super heterodyne configuration with a first IF of 315 MHZ and a second IF of 10.7 MHZ. The received signal from the antenna passes through the same 2.44 GHZ filter the transmitted signal passed through and then passes through the T/R switch to a low noise amplifier (LNA). The filter acts as a preselector to prevent strong out-of-band signals from desensitizing the receiver. The LNA provides approximately 15 dB gain with 2 dB noise figure. An image rejection filter centered on 2.44 GHZ follows the LNA, and is implemented as a strip-line 2-pole bandpass interdigital filter on a separate daughter board.

The first heterodyne mixer is after the image filter. The local oscillator (LO) for the first mixer is a 2.085 to 2.1685 GHZ VCO which is part of the synthesizer. At each hop frequency, the first LO is tuned to a frequency 315 MHZ below the receive frequency. The LO signal passes through the LO filter to the first mixer. This filter is also implemented on the daughter board using strip line and is a 2-pole bandpass interdigital filter centered at 2.125 GHZ. The output of the mixer consists of a number of signals, one of which corresponds to the first IF of 315 MHZ. A 315 MHZ surface acoustic wave (SAW) filter follows the mixer to select the first IF from amongst the products of the mixer.

Following the SAW filter is a stage of 315 MHZ amplification. The signal then passes to the second heterodyne mixer. The second mixer uses a high side LO frequency of 325.7 MHZ so that mixing products are not generated on other channels in the 2.4 to 2.4835 GHZ frequency band. The desired result of this mixer is a 10.7 MHZ signal which then passes through a 10.7 MHZ ceramic 150 KHz bandpass filter to an IF amplifier. The signal passes through another 10.7 MHZ ceramic 150 KHz bandpass filter after the IF amplifier and then to the limiter amplifier. A third 10.7 MHZ ceramic 400 KHz bandpass filter is used as the delay element in the discriminator 68. Discriminator 68 produces an analog version of the serial data stream.

The analog serial data stream is digitized by thresholding the signal using a comparator and a threshold generated from a peak follower. The peak follower follows both the positive and negative peaks of the analog serial data stream-and then generates a threshold signal that is half way between the two peaks. The output of the comparator is the digital received signal output to the digital board 12.

The frequency synthesizer generates the modulated transmit signal, the receiver first LO, and the receiver 2^{nd} LO, each phase locked to the on-board 8 MHZ reference.

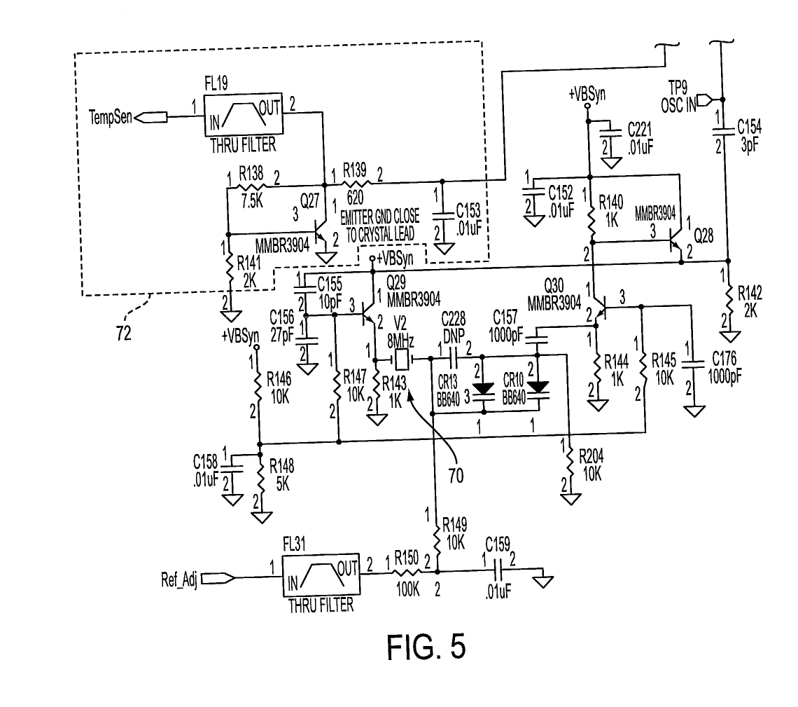

As best seen in FIG. 5, 8 MHZ reference crystal oscillator 70 (or Y2) is characterized in-situ on RF board 13, in accordance with the method of the present invention, and after is controlled by the off-board microprocessor 16. To enable a cost effective solution for the reference an inexpensive crystal is utilized. Because a frequency tolerance of 3 parts per million (ppm) must be maintained for the transceiver to communicate, a frequency compensation routine is programmed for execution with microprocessor 16. The compensation deals with both the initial crystal manufacturing tolerance and maintaining tolerance over the selected temperature range, preferably −20 to 70 degrees Celsius.

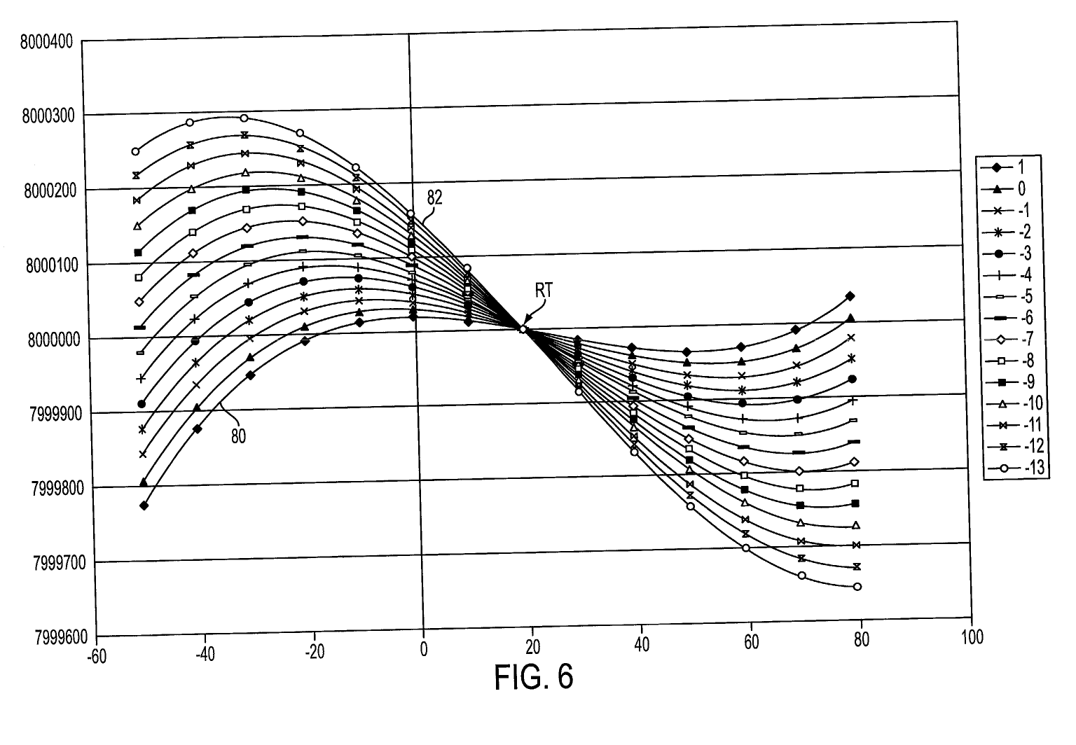

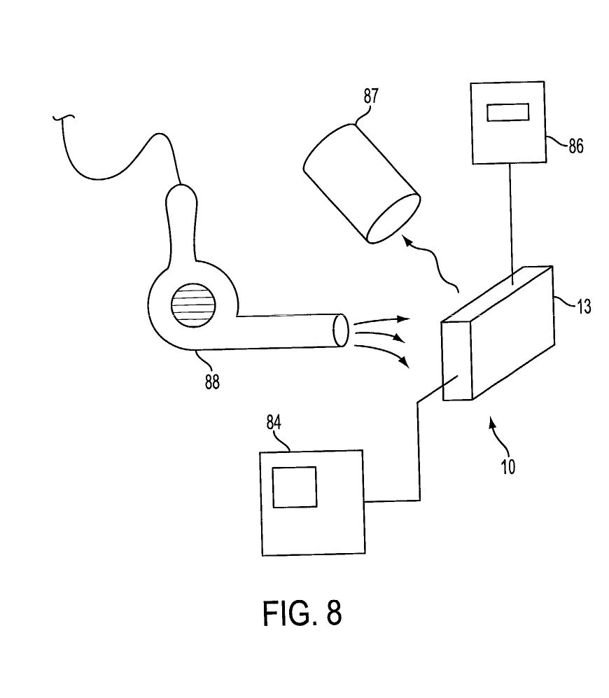

As noted above, crystal oscillator 70 is an inexpensive Crystal Oscillator, and is calibrated in-situ on RF board 13, using a novel method and test fixture or set-up, as best seen in FIG. 8. The method is implemented in a test/calibration controller software algorithm including a selected number of curves (e.g., 15, as seen in FIG. 6) representing Crystal Oscillator frequency variation as a function of temperature, for the selected range of temperatures. FIG. 6 illustrates fifteen exemplary curves, each passing through a point labeled “RT” for a selected reference temperature. As noted above, inexpensive, off-the-shelf, non-calibrated Crystal Oscillator 70 is characterized in-situ on RF board 13 by actuating the crystal at a first selected temperature (e.g., RT), measuring the crystal's frequency of oscillation, changing the temperature of the crystal (and the rest of the RF board) to a second selected temperature, measuring the crystal's frequency of oscillation at the second selected temperature, and then using the two points to select a best-fitting curve describing the temperature variation of the crystal under test, from among the curves stored . Each transceiver then has its crystal oscillator characterized in-situ, and the characterization data is stored, preferably in ROM, for use with an on board temperature sensing circuit 72 (as best sen in FIG. 5), so each transceiver self corrects for temperature variations in real time, when in use. If a transceiver is serviced and Crystal Oscillator 70 is replaced, the method of the present invention can be repeated, to calibrate transceiver performance to the new crystal.

Referring now to FIG. 6, applicants have discovered that there are an optimally useful number of curves representing Crystal Oscillator frequency variation as a function of temperature for the selected range of temperatures for a given crystal. In accordance with the method of the present invention, in the exemplary embodiment, data from fifteen selected curves is stored in a test controller's memory and are included in the test/calibration software. Preferably, by measuring only two temperature/frequency points, enough VCO response data is gathered to select the best fitting curve from the fifteen stored in the test controller's memory. The curves represent frequency as a function of temperature for a temperature range that far exceeds the cold and hot temperature limits of the transceiver. The best fitting curve data is selected and uploaded to a ROM on the transceiver's digital board. The preferred embodiment of the method will be described in greater detail hereinbelow.

Returning to the general theory of operation, the transmitted signal is generated by a VCO, switched on during transmit, operating over a 350 MHZ tuning range roughly centered on 2.44 GHZ. During operation the VCO only tunes in the 2.4 to 2.4835 GHZ band. Having a larger tuning range allows for manufacturing tolerances without the need to tune the oscillators for each manufactured board. During operation, the synthesizer chip is programmed to the required hop frequencies. The chip has a fast and a slow loop response time mode. When a frequency is first programmed the chip is placed in the fast mode. After a selected interval of approximately 3 ms the chip is switched to slow mode. This allows the tuning loop time to settle on the correct frequency and then slows the loop response time so that frequency modulation of the transmitted signal by the data can be accomplished by impressing very small changes on the tuning voltage. If the tuning loop response time were not slowed, then it would be able to partially correct the small tuning voltage impressions and cause pulse droop on the subsequently received signal.

The first LO signal is generated by second LO VCO 52, switched on during receive in the place of the transmit VCO 50. This receive VCO 52 shares the same connections to the synthesizer chip as the transmit VCO 52. As with the transmit VCO, it has a tuning range of 350 MHZ, to allow for manufacturing tolerances. Its tuning range is roughly centered on 2.125 GHZ which is 315 MHZ below the transmit frequencies. During operation, it hops to frequencies in the 2.085 to 2.1685 GHZ band. Unlike the transmit VCO, the synthesizer chip is tuned to a frequency-in fast mode and never switched to slow mode. This allows the synthesizer combination to have a much better close-in phase noise.

The second LO signal is generated by a VCO that has approximately a 35 MHZ tuning range centered on 325.7 MHZ. This VCO is connected to the low frequency section of the dual frequency synthesizer chip. This VCO and this section of the synthesizer chip are energized only while receiving. It is always programmed to 325.7 MHZ.

The RF Board I/O Interface consists of two mechanical connections. Most of the connections are made via a 20 pin dual in-line header. The antenna connection is a microstrip pad and ground to which the coaxial antenna cable is soldered. TTL-compatible input signals on an Rx/Tx-pin are used to control the Rx/Tx switch 56. A logic high on this pin puts the Rx/Tx switch in the receive position and a logic low puts it in the transmit position. Before the radio switches from Rx mode to Tx Mode the Rx/Tx switch 56 should be put in the Tx position. When switching from Tx mode to Rx mode the switch 56 should remain in the Tx position until after the radio is switched from Tx to Rx.

In accordance with the method and structure of the present invention, a very inexpensive VCO is used and is controlled to provide a precise and stable 8 MHz reference frequency output by characterizing the thermal behavior of the oscillator in-situ, on RF board 13, and by operation of temperature sensing circuit 72.

As the quartz crystal temperature varies, the resonant frequency of the crystal varies, that variability depends, in part on the method used to cut the crystal from a quartz blank. The oscillator is therefor also subject to frequency variations over temperature. In accordance with the present invention, a system of 4 major components is used to compensate for frequency variation of the oscillator over a selected temperature range, the frequency variation can be reduced to remain within an acceptable amount of deviation from the desired reference frequency.

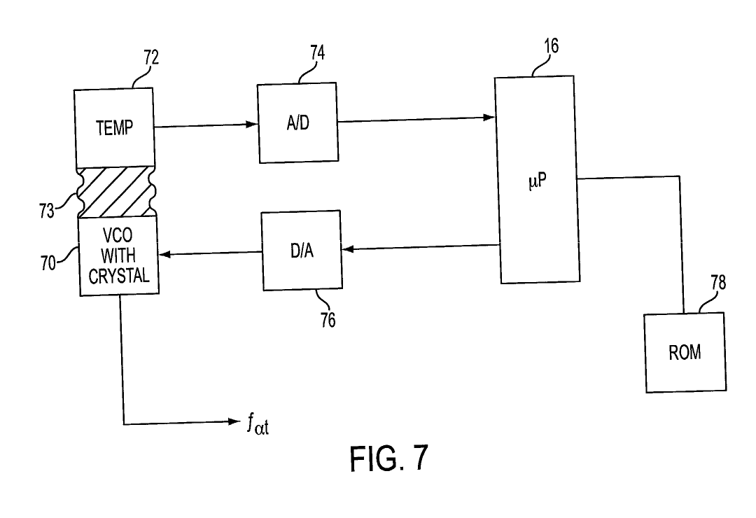

As best seen in FIG. 7, the four major components consist of a temperature sensor circuit 72, a temperature signal analog to digital converter 74, micro-controller 16, a VCO digital to analog converter 76 and a read-only-memory (ROM) 78. Oscillator 70 in which the quartz crystal is used is preferably a voltage-controlled oscillator. As shown in FIG. 7, Temperature sensor 72 and VCO 70 are mounted together within transceiver 10 and a (preferably thermally conductive) mass 73 structurally connects the two; both are preferably mounted on a single printed circuit board so that temperature sensor 72 generates an accurate real-time temperature measurement of the crystal within VCO 70.

Temperature sensor circuit 72 constantly outputs a DC voltage proportional to the temperature of the crystal in the oscillator 70. Micro-controller 16 initiates a conversion by the analog to digital converter 74, which converts the voltage from the temperature sensor to a digital value temperature signal. The micro-controller then uses the digital value temperature signal to look up a VCO compensation value in a novel lookup table preferably stored in ROM 78; this VCO compensation value is written to the VCO digital to analog converter 76. The digital to analog 76 converter performs a conversion to output a DC voltage to the voltage controlled oscillator 70 which alters the frequency of the oscillator in such a way that it pulls it back to the desired reference frequency, in this case, 8 MHZ.

The system just described is an open loop control system that uses pre-stored information in a lookup table to achieve desired VCO compensation results. The lookup table VCO compensation values and the data needed to determine VCO compensation values is described in greater detail below.

The lookup table is, in effect, an amalgam of 3 models, consisting of the voltage controlled oscillator (VCO) model, the temperature sensor model, and the VCO quartz crystal model. Each of these models is obtained by straightforward empirical (i.e., measure, then model) methods, and then combined in a simple one-dimensional lookup table that is created, stored in transceiver ROM 78 and accessed by the micro-controller 16. Micro-controller 16 uses a digitized temperature sensor reading as an index into this table, and retrieves a digitized VCO compensation voltage value that is applied to the VCO 70 to correct the frequency output in-situ, in real time, while transceiver 10 is operating.

Referring to FIG. 8, the creation of the individual models is accomplished using a frequency measuring device such as a spectrum analyzer 84, a voltage measuring device 86, a temperature measuring device such as an infrared temperature sensor 87 and a heating device 88 that can apply heat simultaneously to both the crystal and temperature sensor (which must be in thermal contact with each other, in situ on RF board 13).

Crystal Model Generation:

Crystal model generation is preferably done offline and needs only to be performed once, to supply the models for the lookup table generation. In this procedure, frequency data are taken on an individual crystal in a VCO over a selected temperature range, e.g., 20 degrees Celsius to 50 degrees Celsius; the frequency data are then used as a model.

Due to cutting errors in the crystal manufacturing process, no two crystals are exactly alike. In general, they will have frequency versus temperature profiles that are similar to each other in terms of a mathematical expression, but data taken on many crystals reveals a family of profiles, which translates into the same mathematical model with varying coefficients. For example, empirical data was taken by an early researcher, Bechmann, on “AT cut” quartz crystal cut at a reference angle of −35 degrees, 15 minutes, and described by a power series expansion in temperature including terms up to the third order:

(f−f₀)/f₀=a(T−T₀)+b(T−T₀)²+c(T−T₀)³ (1)

In equation (1), f₀ is defined as the reference frequency and T₀ is defined as the reference temperature. Bechmann found that, within small cut angle ranges about the nominal reference angle, the coefficients a, b, and c could be described as linear functions of angle increments Δθ from the reference angle. Thus the coefficients can be written:

a=a₀+a₁Δθ (2)

b=b₀+b₁Δθ (3)

c=c₀+c₁Δθ (4)

In accordance with the present invention, a computer program generates a family of models by executing the following steps: First, take frequency versus temperature data on a number of crystals and record the data. Next, select the two curves representing sets of data that are most dissimilar. A family of crystal data will have slopes between their two inflection points that go from gradual to steep intersecting at point RT (e.g., curves 80 and 82) as shown in FIG. 6; in this step, for example, one may select the data set with the most gradual slope and the one with the steepest slope. Next, calculate the coefficients of each data set by a third order regression fit employing equations 1-4, above. Using the “a” coefficient from each data set, and a range of angle errors as a parameter, calculate a linear equation. Repeat this process with the “b” and “c” coefficients. Running the angle error parameter over a range and substituting into the three equations just calculated yields a set of third order coefficients for each angle increment. Plotting out a third order equation with coefficients so calculated for each angle increment maps out a family of crystal curves that intersect both sets of data.

Voltage Controlled Oscillator (VCO) Model Generation:

The digital to analog converter (DAC) 76 can be made to apply voltage values to the VCO 70 and adjust the frequency of the VCO output signal. The DAC range is preferably split into a selected number of values (e.g., four); these values can be written to the DAC 76 resulting in a span of voltages being applied to the VCO with frequency measurements taking place at each value. The frequency values yield the tuning sensitivity of the VCO 70 as well as enough data points to perform a third order regression, yielding coefficients to build a model. This model will be referred to as the VCO Table. The table length is the number of bits of the DAC 76 raised to the second power, and is indexed by DAC value with each entry in the table containing a frequency value.

Selection Of Crystal Model:

The first step in generating a lookup table to compensate a given crystal (e.g., 70), is to choose the best crystal model. This can be accomplished by measuring the frequency of the VCO 70 and adjusting the DAC 76; which changes the frequency to match the desired reference frequency (e.g., 8 MHz in the exemplary embodiment). At this point, a temperature reading is made of crystal oscillator 70 and recorded; also, an analog to digital conversion is made of the output signal of temperature sensor 72 and stored, and the DAC setting is stored. An external, artificial heat source such as a heat gun or other hot air source is then directed onto RF board 13 for a finite time and another frequency measurement, temperature measurement, and temperature sensor conversion is made and recorded. A slope is calculated by dividing the frequency difference by the temperature change. All crystal models have frequency versus temperature data; the slopes from all of the crystal models can be calculated from frequency differences between similar temperature differences. The temperature sensor conversion values are saved for the generation of the temperature sensor model. Matching the slope calculated from the heated crystal to the closest slope from the crystal models permits selection of the best or optimum crystal model to use in the lookup table generation. The crystal model will be referred to as the Crystal Table. The Crystal Table is two-dimensional in columns and the length can be any size. One column of the table is temperature while the other column is frequency related to the temperature at the same index entry.

Temperature Sensor Model Generation:

During the selection of the crystal model, temperature sensor conversion data is taken and stored at two different temperatures. As long as the temperature sensor voltage output with respect to temperature is a linear function, a table of temperature values versus analog to digital (A/D) conversion values can be generated from the two data points that have been acquired. As noted above, the table is the length of the number of bits of the A/D 74 raised to the second power (e.g., a 16 bit ADC provides a table length of 16² or 256 entries). This table is the temperature sensor model and will be referred to as the Temperature Table. It will be indexed by AND values and each entry into the table will be a temperature.

Generation Of Lookup Table:

In the method of the present invention, two models now exist as one-dimensional tables, the VCO Table, the Temperature Table. The Crystal Table is a two-dimensional table and needs to be calibrated before creating the final lookup table to be stored in the transceiver's ROM. The Crystal table is calibrated by retrieving the temperature at which VCO 70 was adjusted onto the reference frequency in the crystal model selection phase of the method. This temperature is searched for in the Crystal Table and the corresponding frequency in the table is subtracted from the reference frequency. The difference is added to all frequencies in the table, thereby calibrating it. The lookup table is created by first calculating the AID values that correspond to the extremes of the temperatures that the VCO is expected to operate over. The minimum temperature is searched for in the Temperature Table and the A/D value corresponding to this temperature is recorded and is referred to as “Min A/D”. The maximum temperature is searched for in the Temperature Table and the A/D value corresponding to this temperature is recorded and is referred to as “Max A/D”.

The algorithm for creating the lookup table includes the following method steps: Starting from Min A/D and proceeding to Max AND in a loop, the temperatures corresponding to each of these indexes is pulled from the Temperature Table and are searched for in the Crystal Table. The closest temperature found yields a corresponding frequency for this crystal model. The reference frequency is subtracted from the corresponding frequency, yielding the frequency error at this temperature sensor reading. The frequency error is subtracted from the reference frequency, and searched for in the VCO Table, yielding a DAC input value to bring the VCO back to the reference frequency. The table values below Min A/D and above Max AND are filled in with estimated values derived from plots such as FIG. 6. This lookup table can now be used by the micro-controller 16 in real time to update the VCO as temperature changes cause corresponding frequency changes.

Practitioners in this art will recognize that the present invention makes available an economical, compact, frequency hopping, spread spectrum, wireless data telemetry transceiver comprising a frequency hopping transmitter, a frequency hopping receiver, a voltage controlled oscillator configured to receive an analog VCO control signal and generating a selected frequency output signal in response thereto and supplied to either or both the frequency hopping transmitter and frequency hopping receiver, a microprocessor connected to a memory, a temperature sensor situated within the transceiver to measure the temperature of the voltage controlled oscillator in-situ, and generating a VCO in-situ temperature signal in response. In addition, the memory is configured to store a plurality of pre-programmed VCO compensation values corresponding to a plurality of VCO in-situ temperature signals, and the microprocessor is programmed to receive the VCO in-situ temperature signals, retrieving a corresponding pre-programmed VCO compensation value from memory and generating a digital temperature compensated VCO control signal in response. Further, a digital to analog converter responsive to the digital temperature compensated VCO control signal is configured to generate an analog temperature compensated VCO control signal in response, and the voltage controlled oscillator generates a temperature compensated selected frequency output signal in response to the analog temperature compensated VCO control signal.

Additionally, the transceiver further comprises an analog to digital converter configured to receive the VCO in-situ temperature signal and generate a digital VCO in-situ temperature signal in response, and, preferably, the microprocessor is programmed to receive the digital VCO in-situ temperature signal.

As will be appreciated by those skilled in the art, the method of the present invention includes a number of steps. Temperature sensor 72 constantly outputs a signal proportional to the temperature of the crystal in the oscillator 70. Micro-controller 16 initiates a conversion via ADC 74 and micro-controller 16 then uses the ADC output signal to retrieve an adjustment number in a pre-programmed lookup table stored in a memory 78; the adjustment number is input to DAC 76, which then performs a conversion to output a DC voltage to the VCO 70, adjusting the frequency of the oscillator to the desired reference frequency, thus effectively providing an open loop VCO control system.

As set forth above, the adjustment number in the pre-programmed lookup table is derived from a crystal model and a temperature sensor model. For the Crystal Model: first, frequency versus temperature data is taken on a number of crystals. Next, the two curves representing sets of data that are most dissimilar, e.g., curves 80 and 82 as shown in FIG. 6 are selected; in this step, the data set with the most gradual slope (curve 80) and the one with the steepest slope (curve 82) are selected. Next, the coefficients of each data set are calculated by a third order regression fit employing equations 1-4, above. Using the “a” coefficient from each data set, and a range of angle errors as a parameter, a linear equation is calculated. This process is repeated with the “b” and “c” coefficients. Running the angle error parameter over a range, and substituting into the three equations just calculated, a set of third order coefficients for each angle increment is generated. Plotting out a third order equation with coefficients calculated in this way, for each angle increment, a family of crystal curves that intersect both sets of data are mapped out.

For the Voltage Controlled Oscillator (VCO) Model, digital to analog converter (DAC) 76 applies selected voltage values to the VCO 70 and adjusts the frequency. The DAC range is split into 4 values, and these values are written to the DAC 76, resulting in a span of voltages being applied to the VCO with frequency measurements taking place at each value. The frequency values yield the tuning sensitivity of the VCO 70 as well as enough data points to perform a third order regression, yielding coefficients to build a model. This model is referred to as the VCO Table. The table is the length of the number of bits of the DAC 76 raised to the second power, and is indexed by DAC value with each entry in the table containing a frequency value.

The first step in generating a lookup table to compensate a given crystal (e.g., 70), is selecting the best crystal model. This is accomplished by measuring the frequency of the VCO 70 and adjusting the DAC 76, changing the frequency to match the desired reference frequency (e.g., 8 MHz in the exemplary embodiment). A temperature reading is then made of crystal oscillator 70 and recorded; also, an analog to digital conversion is made of the temperature sensor 72 and stored, and the DAC setting is stored. A heat source such as a temporarily fixed heat gun is then turned on for a finite time and another frequency measurement, temperature measurement, and temperature sensor conversion is made and recorded. A slope is calculated by dividing the frequency difference by the measured temperature change. All of the crystal models have frequency versus temperature as their data; the slopes from all of the crystal models are calculated from their frequency differences between similar temperature differences. The temperature sensor conversion values are saved for the generation of the temperature sensor model. Matching the slope calculated from the heated crystal to the closest slope from the crystal models effectively yields the best crystal model to use in the lookup table generation. The selected best crystal model will be referred to as the Crystal Table. The Crystal Table is two-dimensional in columns and the length can be any size. One column of the table is temperature while the other column is frequency related to the temperature at the same index entry.

During the selection of the best crystal model, temperature sensor conversion data is taken and stored at two different temperatures. As long as the temperature sensor voltage output with respect to temperature is a linear function, a table of temperature values versus analog to digital (A/D) conversion values is to be generated from the two data points that have been acquired. As noted above, the table is the length of the number of bits of the AND (e.g., A/D 74) raised to the second power. This table is the temperature sensor model and will be referred to as the Temperature Table. It will be indexed by A/D values and each entry into the table will be a temperature.

In the method of the present invention, two models then exist as one-dimensional tables, the VCO Table and the Temperature Table. The Crystal Table is a two dimensional table and is calibrated before creating the final lookup table to be stored in the transceiver's ROM for use to perform in-situ VCO adjustment. The crystal table is calibrated by retrieving the temperature at which VCO 70 was adjusted onto the reference frequency in the crystal model selection phase of the method. This temperature is searched for in the Crystal Table and the corresponding frequency in the table is subtracted from the reference frequency. The difference is added to all frequencies in the table, thereby calibrating the crystal table.

The lookup table is created by first calculating the AND values that correspond to the extremes of the temperatures that the VCO is expected to operate over. The minimum temperature is searched for in the Temperature Table and the A/D value corresponding to this temperature is recorded and is designated “Min A/D”. The maximum temperature is searched for in the Temperature Table and the A/D value corresponding to this temperature is recorded and designated “Max A/D”.

The algorithm for creating the lookup table includes the following method steps: Starting from Min A/D and proceeding to Max A/D in a loop, the temperatures corresponding to each of these indexes is pulled from the Temperature Table and searched for in the Crystal Table. The closest temperature found yields a corresponding frequency for this crystal model. The reference frequency is subtracted from the corresponding frequency, yielding the frequency error at this temperature sensor reading. The frequency error is subtracted from the reference frequency, and searched for in the VCO Table, yielding a DAC value corresponding to the DAC value that must be written to bring the VCO back to the reference frequency. The table values below Min A/D and above Max A/D are filled in with estimated values derived from plots (such as FIG. 6.) This lookup table is then used by the micro-controller 16 in real time to update or adjust the VCO as a temperature change causes a corresponding frequency change.

If, after years of use, it is discovered that the crystal properties have changed, the crystal characterization procedure can be repeated, whereupon ROM 78 is re-programmed with updated information, thus permitting more accurate adjustment of the oscillator frequency in later years. The re-characterization and re-programming procedure can be repeated periodically for as long as a given transceiver 10 (or any other device including a VCO 70) is in use. If, for example, the device including a given VCO is subjected to extreme conditions such as extreme environmental conditions, then it may be prudent to require that the re-characterization and re-programming procedure be repeated before the device is placed back in service. This is a capability that cannot be readily duplicated when relying only on a TCXO, and not having the ability to practice the method of the present invention.

In as much as the present invention is subject to various modifications and changes in detail, the above description of a preferred embodiment is intended to be exemplary only and not limiting. It is believed that other modifications, variations and changes will be suggested to those skilled in the art in view of the teachings set forth herein.

What is claimed is:

1. An economical, compact, frequency hopping, spread spectrum, wireless data telemetry transceiver, comprising:
a frequency hopping transmitter;
a frequency hopping receiver;
a voltage controlled oscillator including a crystal and configured to receive an analog VCO control signal and generating a selected frequency output signal in response thereto and supplied to at least one of said frequency hopping transmitter and frequency hopping receiver;
a microprocessor connected to a memory and to said voltage controlled oscillator;
a temperature sensor in thermal contact with said voltage controlled oscillator and situated within the transceiver to measure the temperature of the voltage controlled oscillator in-situ, generating a VCO in-situ temperature signal in response thereto;
said memory being configured to store a plurality of pre-programmed VCO compensation values corresponding to a plurality of VCO in-situ temperature signals;
said microprocessor being programmed to receive one of said VCO in-situ temperature signals, retrieve a corresponding pre-programmed VCO compensation value from memory and generate a digital temperature compensated VCO control signal in response thereto;
a digital to analog converter responsive to said digital temperature compensated VCO control signal and configured to generate an analog temperature compensated VCO control signal in response thereto;
wherein said voltage controlled oscillator generates a temperature compensated selected frequency output signal in response to said analog temperature compensated VCO control signal.

2. The economical, compact, frequency hopping, spread spectrum, wireless data telemetry transceiver of claim 1, further comprising an analog to digital converter configured to receive said VCO in-situ temperature signal and generate a digital VCO in-situ temperature signal in response thereto.

3. The economical, compact, frequency hopping, spread spectrum, wireless data telemetry transceiver of claim 2, wherein said microprocessor is programmed to receive said digital VCO in-situ temperature signal.

4. The economical, compact, frequency hopping, spread spectrum, wireless data telemetry transceiver of claim 3, wherein said voltage controlled oscillator selected frequency output signal is supplied to said frequency hopping transmitter and to said frequency hopping receiver

5. The economical, compact, frequency hopping, spread spectrum, wireless data telemetry transceiver of claim 3, wherein said voltage controlled oscillator and said temperature sensor in thermal contact with said voltage controlled oscillator are both mounted on a single printed circuit board.

6. The economical, compact, frequency hopping, spread spectrum, wireless data telemetry transceiver of claim 1, wherein said voltage controlled oscillator crystal is a quartz crystal.

7. The economical, compact, frequency hopping, spread spectrum, wireless data telemetry transceiver of claim 1, wherein said voltage controlled oscillator quartz crystal comprises an AT cut crystal segment, cut at a selected reference angle.

8. A method for calibrating a Voltage Controlled crystal oscillator in-situ, comprising the steps of:
a) Supplying a first control voltage signal to the Voltage Controlled crystal oscillator;
b) Measuring the temperature of crystal within the Voltage Controlled crystal oscillator with a temperature sensor, and generating an analog temperature output signal in response thereto;
c) Converting the analog temperature output signal to a digital temperature output signal;
d) Selecting an optimum digital Voltage Controlled crystal oscillator adjustment value from a plurality of distinct digital Voltage Controlled crystal oscillator adjustment values stored in a memory;
e) Converting the selected optimum digital Voltage Controlled crystal oscillator adjustment value to a selected optimum analog Voltage Controlled crystal oscillator adjustment signal; and
f) Supplying said selected optimum analog Voltage Controlled crystal oscillator adjustment signal to said Voltage Controlled crystal oscillator as a subsequent control voltage signal.

9. The method for calibrating a Voltage Controlled crystal oscillator in-situ of claim 8, further comprising the steps of:
a′) generating a plurality of distinct digital Voltage Controlled crystal oscillator adjustment values; and
a″) storing said plurality of distinct digital Voltage Controlled crystal oscillator adjustment values in a memory.

10. The method for calibrating a Voltage Controlled crystal oscillator in-situ of claim 9, wherein the generating step, a′, comprises:
a′-1) measuring the frequency of the Voltage Controlled crystal oscillator output signal at a first selected temperature;
a′-2) measuring the frequency of the Voltage Controlled crystal oscillator output signal at a second selected temperature;
a′-3) deriving the slope of the frequency versus temperature curve for the Voltage Controlled crystal oscillator from the frequency measurements at said first and second selected temperatures;
a′-4) selecting an optimum frequency versus temperature characteristic curve from a plurality of stored frequency versus temperature characteristic curves for the Voltage Controlled crystal oscillator, wherein each stored frequency versus temperature characteristic curve comprises a plurality of distinct digital Voltage Controlled crystal oscillator adjustment values; and thereby
a′-5) selecting an optimum plurality of distinct digital Voltage Controlled crystal oscillator adjustment values.

11. A method for calibrating a Voltage Controlled crystal oscillator comprising the steps of:
a) measuring a frequency of the Voltage Controlled crystal oscillator output signal at a first selected temperature;
b) measuring the frequency of the Voltage Controlled crystal oscillator output signal at a second selected temperature;
c) deriving the slope of a frequency versus temperature curve for the Voltage Controlled crystal oscillator from the frequency measurements at said first and second selected temperatures;
d) selecting an optimum frequency versus temperature characteristic curve from a plurality of stored frequency versus temperature characteristic curves for the Voltage Controlled crystal oscillator, wherein each stored frequency versus temperature characteristic curve comprises a plurality of distinct digital Voltage Controlled crystal oscillator adjustment values; and
e) storing the optimum plurality of distinct digital Voltage Controlled crystal oscillator adjustment values in a memory.

12. The method for calibrating a Voltage Controlled crystal oscillator of claim 11, further comprising the steps of:
f) Supplying a first control voltage signal to the Voltage Controlled crystal oscillator;
g) Measuring the temperature of crystal within the Voltage Controlled crystal oscillator with a temperature sensor, and generating an analog temperature output signal in response thereto;
h) Converting the analog temperature output signal to a digital temperature output signal; and
i) Selecting an optimum digital Voltage Controlled crystal oscillator adjustment value from said optimum plurality of distinct digital Voltage Controlled crystal oscillator adjustment values stored in memory.

13. The method for calibrating a Voltage Controlled crystal oscillator of claim 12, further comprising the step of:
j) Converting the selected optimum digital Voltage Controlled crystal oscillator adjustment value to a selected optimum analog Voltage Controlled crystal oscillator adjustment signal.

14. The method for calibrating a Voltage Controlled crystal oscillator of claim 13, further comprising the step of:
k) Supplying said selected optimum analog Voltage Controlled crystal oscillator adjustment signal to said Voltage Controlled crystal oscillator as a subsequent control voltage signal.
